(19) United States
(12) Patent Application Publication
(10) Pub. No.: US 2025/0219224 A1
(43) Pub. Date: Jul. 3, 2025

(54) COMPOSITE CROSS-BEAM FOR ELECTRIC VEHICLE BATTERY PACKS

(71) Applicants: GM GLOBAL TECHNOLOGY OPERATIONS LLC, Detroit, MI (US); Northwestern University, Evanston, IL (US)

(72) Inventors: Mary GILLIAM, Farmington Hills, MI (US); Andrew P. OURY, Troy, MI (US); Selina Xinyue ZHAO, Rochester Hills, MI (US); Hui-Ping WANG, Troy, MI (US); Lu HUANG, Troy, MI (US); Jian YAO, Shanghai (CN); Venkateshwar R. AITHARAJU, Troy, MI (US); Yunzhi XU, Sterling Heights, MI (US)

(21) Appl. No.: 18/418,828

(22) Filed: Jan. 22, 2024

(30) Foreign Application Priority Data
Dec. 27, 2023 (CN) 202311829887.0

(51) Int. Cl. H01M 50/249; H01M 10/647; H01M 10/653; H01M 10/6568; H01M 50/209; H01M 50/227; H01M 50/231

(52) U.S. Cl. CPC H01M 50/249; H01M 10/647; H01M 10/653; H01M 10/6568; H01M 50/209; H01M 50/227; H01M 50/231

(57) ABSTRACT

A beam for supporting a plurality of prismatic batteries in battery enclosure of an electric vehicle includes a base, having a lower elongate horizontal flange, and an upper elongate horizontal flange, narrower than the lower elongate horizontal flange, spaced above the lower elongate horizontal flange by a vertical web. A web member can be disposed on the upper elongate horizontal flange of the base, and includes first and second elongate exterior vertical wall members. At least two elongate inserts disposed between the vertical exterior wall members, and configured to at least in part form at least one longitudinally extending channel between them. The elongate inserts can be made of metal and the longitudinally extending channel provides a pathway for cooling fluid. A cap can engage the upper edges of the vertical wall members and enclose the metal inserts in the space between the first and second vertical wall members.

### CROSS-REFERENCE TO RELATED APPLICATIONS

This application claims the benefit of Chinese Patent Application No. 202311829887.0, filed on Dec. 27, 2023. The entire disclosure of the application referenced above is incorporated herein by reference.

### FIELD OF THE INVENTION

This disclosure relates to composite cross beams for electric vehicle battery packs.

### INTRODUCTION

Electrical vehicle battery packs typically have a plurality of transversely extending metal cross-beams for supporting rows of prismatic batteries in the spaced between the cross-beams. In addition to supporting the batteries, the cross-beams also add strength to the battery pack, and help to conduct heat away from the batteries in the pack. However, metallic cross-beams typically are heavy, adding significantly to the mass of the battery pack and to the electric vehicle containing the battery pack. Furthermore, metallic beams usually have to be electrically insulated in case of battery failure.

### SUMMARY

Embodiments of this disclosure provide a composite cross-beam for electric vehicle battery packs. According to one such embodiment, a beam is provided for supporting a plurality of prismatic batteries in a battery enclosure of an electric vehicle. The beam can comprise a base, having a lower elongate horizontal flange, and an upper elongate horizontal flange, narrower than the lower elongate horizontal flange, spaced and generally centered above lower elongate horizontal flange by a web.

A web-member can be disposed on the upper elongate horizontal flange of the base. The web member can have first and second elongate exterior vertical wall members, with upper edges and lower edges. The lower edges engage and are supported upon, the base. At least two elongate inserts, which optionally may be made of metal, can be disposed between the vertical exterior wall members, and are configured to form at least one longitudinally extending channel between them, for the circulation of cooling fluid.

A cap can engage the upped edges of the exterior vertical wall members, and enclose the metal inserts in the space between the first and second exterior vertical wall members.

In some embodiments the base can be made of carbon fiber composite. In some embodiments, the first and second exterior elongate vertical wall members are made of carbon fiber composite. The first and second elongate exterior vertical wall members can comprise between about 35% and about 50% fiber reinforcement, and in some embodiments at least about 80% of the fibers in the first and second elongate exterior vertical wall members are oriented parallel to the longitudinal direction.

In some embodiments, the elongate inserts are made of metal, such as copper, aluminum, and magnesium. In some embodiments the cap is made of metal, composite, or a polymer.

In some embodiments a glass fiber layer between each metal insert and its respective elongate external vertical web member. There can be a plurality of surface features on the interior surfaces of the elongate vertical web members increasing the turbulence of cooling fluid in the at least one longitudinally extending channel between the elongate vertical wall members.

In some embodiments the at least two elongate inserts can be at least in part bonded to the elongate exterior vertical wall members. In other embodiments the at least two elongate inserts can be at least in part molded into the elongate exterior vertical wall members.

The exterior surface of each elongate exterior vertical wall member can be non-conductive. In some embodiments each elongate exterior vertical wall member has a thickness of about 0.75 to about 1 mm. and a thermal conductivity in the range of from about 0.4 to about 0.8 W/mK. In other embodiments, each elongate exterior vertical wall member has a thickness of about 1.5 mm. and a thermal conductivity in the range of from about 0.8 to about 1.2 W/mK.

### BRIEF DESCRIPTION OF THE DRAWINGS

The present disclosure will become more fully understood from the detailed description and the accompanying drawings, wherein:

FIG. 1 is a perspective view of base for a composite cross-beam for electric vehicle battery packs in accordance with the principles of this disclosure;

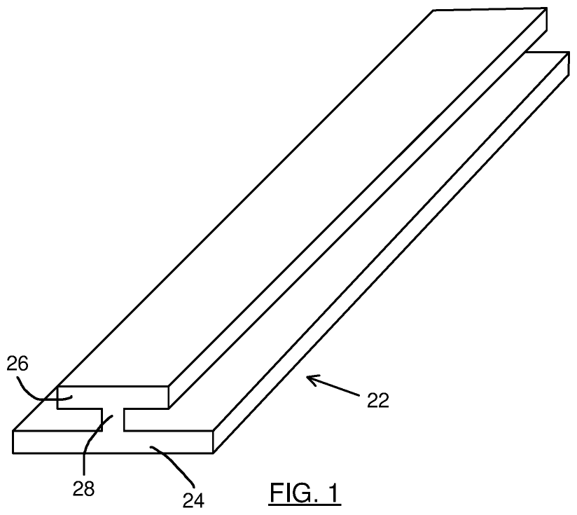

FIG. 2 is a perspective view of the first and second elongate exterior vertical wall members, and elongate metal inserts for a composite cross-beam for electric vehicle battery packs in accordance with the principles of this disclosure;

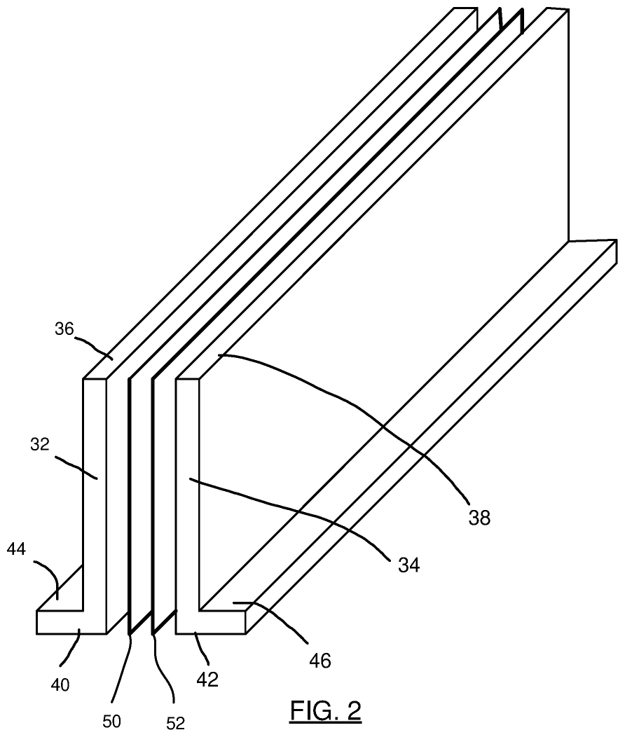

FIG. 3 is a perspective view of the first and second elongate exterior vertical wall members, showing structure on their interior surfaces for increasing turbulence;

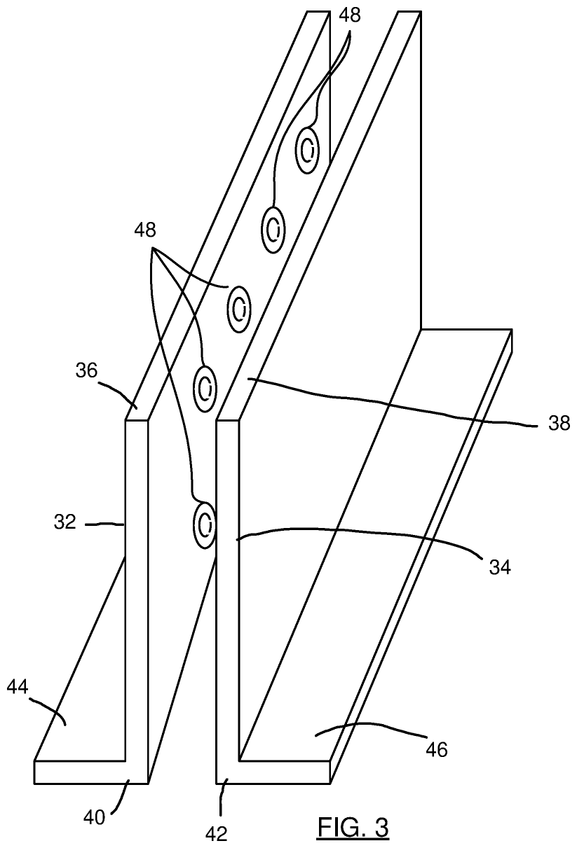

FIG. 4 is a perspective view of the cap for a composite cross-beam for electric vehicle battery packs in accordance with the principles of this disclosure;

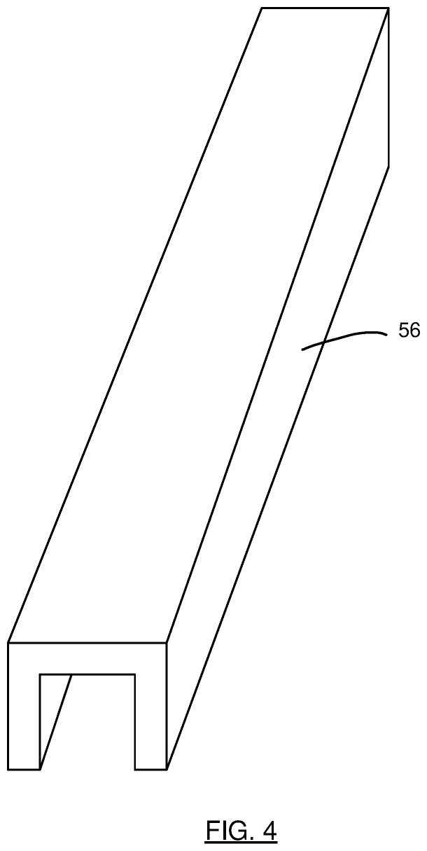

FIG. 5 is a partially exploded view of a composite cross-beam for electric vehicle battery packs in accordance with the principles of this disclosure;

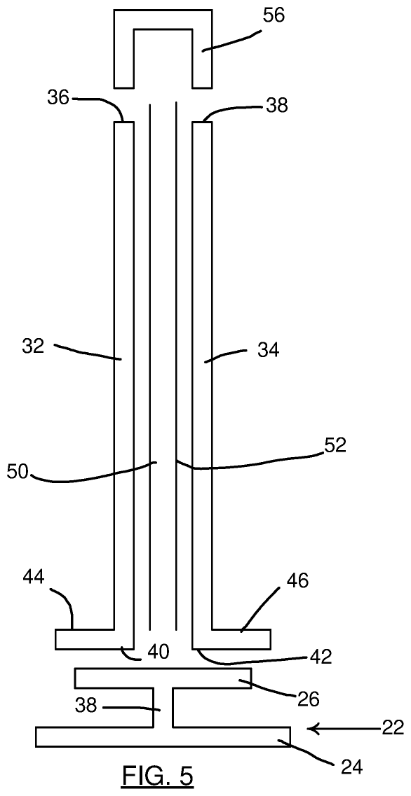

FIG. 6 is a vertical end elevation view of a composite cross-beam for electric vehicle battery packs in accordance with the principles of this disclosure;

FIG. 7 is a vertical cross-sectional view of a composite cross-beam for electric vehicle battery packs in accordance with the principles of this disclosure, showing a first possible arrangement of longitudinal fluid cooling channels;

FIG. 8 is a vertical cross-sectional view of a composite cross-beam for electric vehicle battery packs in accordance with the principles of this disclosure, showing a second possible arrangement of longitudinal fluid cooling channels;

FIG. 9 is a vertical cross-sectional view of a composite cross-beam for electric vehicle battery packs in accordance with the principles of this disclosure, showing a third possible arrangement of longitudinal fluid cooling channels; and

FIG. 10 is a vertical cross-sectional view of a composite cross-beam for electric vehicle battery packs in accordance with the principles of this disclosure, showing a fourth possible arrangement of longitudinal fluid cooling channels.

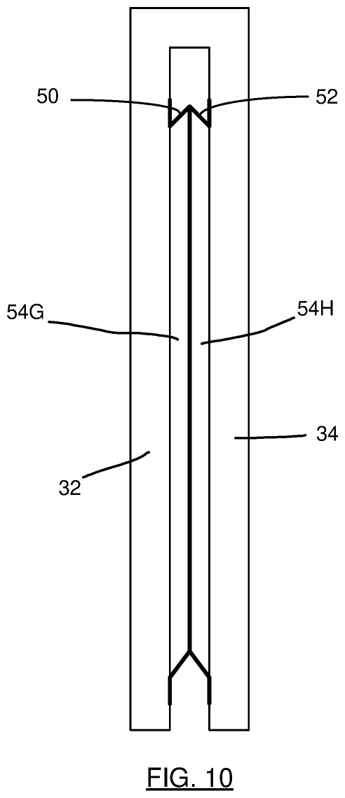

### DETAILED DESCRIPTION

Embodiments of this disclosure provide a composite cross-beam for electric vehicle battery packs. Cross-beams are disposed transversely in battery backs to support prismatic batteries arranged within the battery pack. Batteries are supported between adjacent cross-beams, which also help assist in cooling the batteries in the pack.

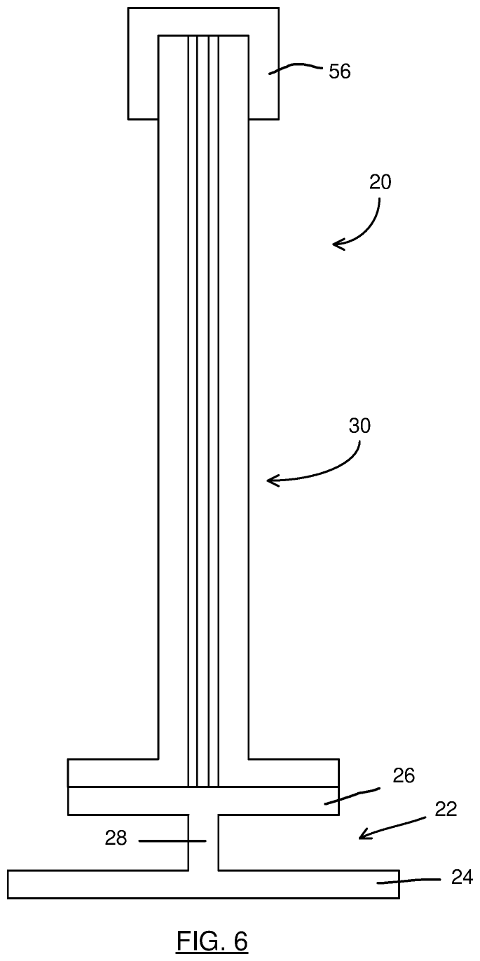

According to one such embodiment of this disclosure, a beam 20 (FIG. 6) is provided for supporting a plurality of prismatic batteries in a battery enclosure of an electric vehicle. The beam 20 can comprise a base 22, having a lower elongate horizontal flange 24, and an upper elongate horizontal flange 26 that is narrower than the lower elongate horizontal flange, and is spaced and generally centered above lower elongate horizontal flange by a web 28.

The base 22 is preferably made from a carbon fiber composite so that the base is strong, light-weight, and substantially electrically non-conductive, and substantially non-reactive to the components of the batteries that will be supported on the beam.

A web member 30 can be disposed on the upper elongate horizontal flange 26 of the base 22. The web 30 member can be secured to the base 22 for example with heat welding, or other suitable means. The web member 30 can have first and second elongate exterior vertical wall members 32 and 34, with upper edges 36, 38 and lower edges 40, 42, respectively. The lower edges 40, 42 can have outwardly projecting flanges 44, 46 projecting outwardly therefrom. These flanges 44, 46 can be supported on, and secured to the base 22. As discussed in more detail below the interior faces of the elongate exterior vertical wall members 32 and 34 can have features 48 formed therein.

The first and second elongate exterior vertical wall members 32 and 34 can be made of a reinforced polymeric composite material, for example thermoplastic resin reinforced with carbon fibers, glass fibers, high-strength polymeric fibers, or other suitable material. The fibers can be unidirectional, woven, or chopped fibers. The fillers also may be particles or platelets. At least the external surface of the wall members 32 and 34 are non-electrically conductive. The first and second elongate exterior vertical wall members 32 and 34 can comprise between about 35% and about 50% fiber reinforcement, and in some embodiments at least about 80% of the fibers in the first and second elongate exterior vertical wall members are oriented parallel to the longitudinal direction.

At least two elongate metal inserts 50 and 52 can be disposed between the vertical exterior wall members 32 and 34, and are configured to form at least one longitudinally extending channel 54 between them, for the circulation of cooling fluid. The metal inserts 50 and 52 are preferably made from aluminum, copper or other suitable heat-conductive metal or metal alloy.

In some embodiments the at least two metal inserts 50 and 52 can be bonded to bonded to one of the elongate exterior vertical wall members 32 and 34. In other embodiments the at least two metal inserts 50 and 52 can be molded into one of the elongate exterior vertical wall members 32 and 34.

A cap 56 can engage the upped edges 36, 38 of the of the exterior vertical wall members vertical exterior wall members 32 and 34, and enclose the metal inserts 50 and 52 in the space between the first and second exterior vertical wall members.

The first and second elongate exterior vertical wall members can comprise between about 35% and about 50% fiber reinforcement, and in some embodiments at least about 80% of the fibers in the first and second elongate exterior vertical wall members are oriented parallel to the longitudinal direction. In some embodiments each elongate exterior vertical wall member 32 and 34 has a thickness of about 0.75 to about 1 mm. and a thermal conductivity in the range of from about 0.4 to about 0.8 W/mK. In other embodiments, each elongate exterior vertical wall member 30 and 34 has a thickness of about 1.5 mm. and a thermal conductivity in the range of from about 0.8 to about 1.2 W/mK.

In some embodiments a glass fiber layer between each metal insert and its respective elongate external vertical web member. There can be a plurality of surface features 48 on the interior surfaces of the elongate vertical web members increasing the turbulence of air flow in the space between the elongate vertical wall members.

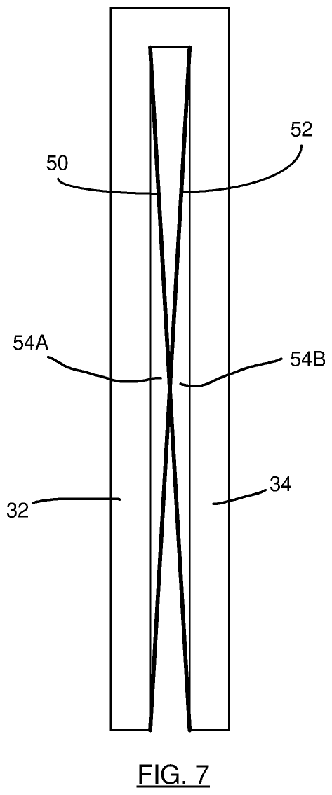

The beams 20 can be formed with channels 54 that allow for the circulation of cooling fluid (liquid or gas) among the batteries in contact with the beams. For example as shown in FIG. 7, which is a vertical cross section view of one embodiment of a composite cross-beam for electric vehicle battery packs in accordance with the principles of this disclosure, channels 54A and 54B are formed adjacent the interior walls of the elongate exterior vertical wall members 32 and 34. As described above, surface features 48 on the interior surfaces of the elongate exterior vertical wall members 32 and 34 can increase the turbulence and heat transfer to the fluid in the channels 41A and 54B.

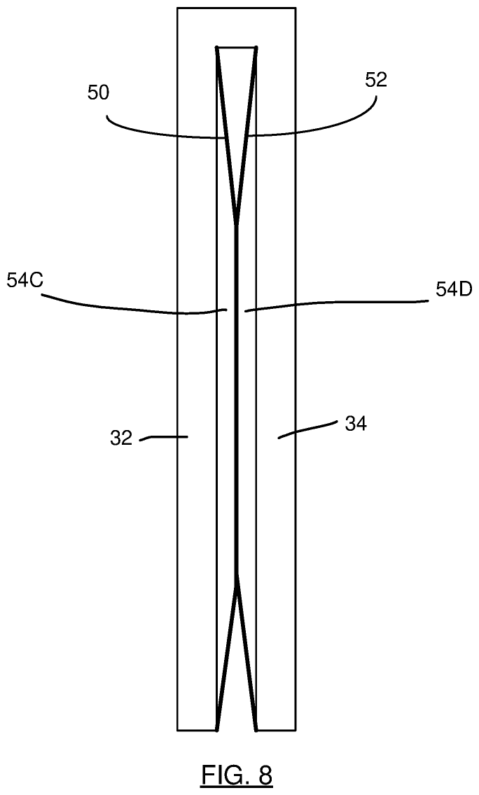

As shown in FIG. 8, which is a vertical cross section view another embodiment of a composite cross-beam for electric vehicle battery packs in accordance with the principles of this disclosure, channels 54C and 54D are formed adjacent the interior walls of the elongate exterior vertical wall members 32 and 34. As described above, surface features 48 on the interior surfaces of the elongate exterior vertical wall members 32 and 34 can increase the turbulence and heat transfer to the fluid in the channels 54C and 54D.

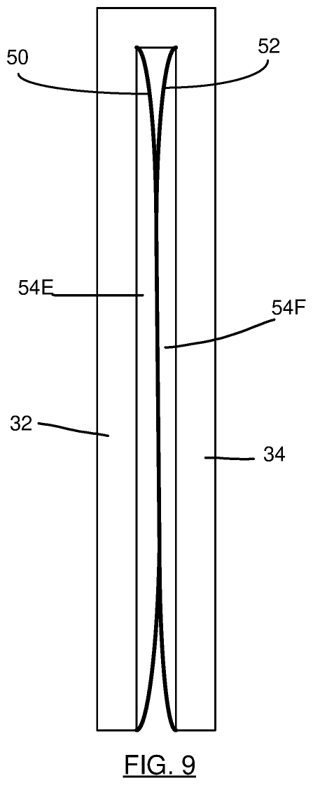

As shown in FIG. 9, which is a vertical cross section view another embodiment of a composite cross-beam for electric vehicle battery packs in accordance with the principles of this disclosure, channels 54E and 54F are formed adjacent the interior walls of the elongate exterior vertical wall members 32 and 34. As described above, surface features 48 on the interior surfaces of the elongate exterior vertical wall members 32 and 34 can increase the turbulence and heat transfer to the fluid in the channels 54E and 54F.

As shown in FIG. 9, which is a vertical cross section view another embodiment of a composite cross-beam for electric vehicle battery packs in accordance with the principles of this disclosure, channels 54G and 54H are formed adjacent the interior walls of the elongate exterior vertical wall members 32 and 34. As described above, surface features 48 on the interior surfaces of the elongate exterior vertical wall members 32 and 34 can increase the turbulence and heat transfer to the fluid in the channels 54G and 54H.

In addition to supporting the batteries, the assembled beams 20 add to the structural integrity of the battery pod into which they are incorporated. The beams 20 provide a substantial weight reduction over metal beams, and because of their composite construction eliminate the need for a separate insulating coating. The composite, however, is preferably sufficient flexible to accommodate expansion of the batteries over their life. Further, the beams provide cooling channels 54 to help maintain the batteries supported by the beams in their desired operating temperature range.

What is claimed is:

1. A beam for supporting a plurality of prismatic batteries in battery enclosure of an electric vehicle, the beam comprising:
a base, having a lower elongate horizontal flange, and an upper elongate horizontal flange, narrower than the lower elongate horizontal flange, spaced and generally centered above lower elongate horizontal flange by a vertical web;
a web member, disposed on the upper elongate horizontal flange of the base, the web member comprising first and second elongate exterior vertical wall members, having upper edges and lower edges, with the lower edges engaging the base; at least two elongate inserts disposed between the vertical exterior wall members, and configured to form at least one longitudinally extending channel for cooling fluid in the web member.

2. The beam according to claim 1, further comprising a cap engaging the upped edges of the vertical wall members, and enclosing the inserts in the space between the first and second elongate exterior vertical wall members.

3. The beam according to claim 1 wherein the base is made of carbon fiber composite.

4. The beam according to claim 1 wherein the first and second elongate vertical wall members are made of carbon fiber composite.

5. The beam according to claim 1 further comprising a glass fiber layer on the exterior surfaces of the first and second elongate vertical wall members.

6. The beam according to claim 1 wherein the elongate inserts are made of metal.

7. The beam according to claim 1 further comprising a plurality of surface features on the interior surfaces of the elongate vertical web members increasing turbulence of cooling fluid in the channels formed between the elongate inserts and the elongate vertical wall members.

8. The beam according to claim 1 wherein at least portions of the at least two elongate inserts are each bonded to at least one of the elongate exterior vertical wall members.

9. The beam according to claim 1 wherein at least portions of the at least two elongate inserts are molded into at least one of the elongate exterior vertical wall members.

10. The beam according to claim 1 wherein at least the exterior surface of each elongate exterior vertical wall member is electrically non-conductive.

11. The beam according to claim 10 wherein each elongate exterior vertical wall member has a thickness of about 0.75 to about 1 mm. and a thermal conductivity in a range of from about 0.4 to about 0.8 W/mK.

12. The beam according to claim 10 wherein each elongate exterior vertical wall member has a thickness of about 1.5 mm. and a thermal conductivity in a range of from about 0.8 to about 1.2 W/mK.

13. The beam according to claim 1 wherein the first and second elongate exterior vertical wall members comprise between about 35% and about 50% fiber reinforcement.

14. The beam according to claim 13 wherein at least about 80% of the fibers in the first and second elongate exterior vertical wall members are oriented parallel to the longitudinal direction.

15. A beam for supporting a plurality of prismatic batteries in battery enclosure of an electric vehicle, the beam comprising:
a base of a composite polymeric materials, having a lower elongate horizontal flange, and an upper elongate horizontal flange, narrower than the lower elongate horizontal flange, spaced and generally centered above lower elongate horizontal flange by a vertical web;
a web member, disposed on the upper elongate horizontal flange of the base, the web member comprising first and second elongate exterior vertical wall members of a composite polymeric material and having an electrically non-conductive exterior surface, and upper edges and lower edges, with the lower edges engaging the base; at least two elongate inserts disposed between the vertical exterior wall members, and configured to form at least one longitudinally extending channel in the web member; and
a cap engaging the upped edges of the vertical wall members, and enclosing the metal inserts in the space between the first and second vertical wall members.

16. The beam according to claim 15 wherein the elongate inserts are made of metal.

17. The beam according to claim 15 wherein the cap is made of at least one of metal, composite, and a polymer.

18. The beam according to claim 15 wherein the electrically non-conductive exterior surface of the elongate vertical web members comprises a layer of a glass fiber.

19. The beam according to claim 15 further comprising a plurality of surface features on the interior surfaces of the elongate vertical web members increasing the turbulence of fluid in the at least one longitudinally extending channel in the web member.
